(19) United States
(12) Patent Application Publication
(10) Pub. No.: US 2025/0300410 A1
(43) Pub. Date: Sep. 25, 2025

(54) ELECTRICAL ISOLATION MODULE FOR POWER OVER ETHERNET AND CONNECTOR SOCKET AND ELECTRONIC DEVICE FOR SAME

(71) Applicant: FUTUREWAFER TECH CO., LTD., Taoyuan City (TW)

(72) Inventor: Cheng-Hao Ho, Taoyuan City (TW)

(73) Assignee: FUTUREWAFER TECH CO., LTD., Taoyuan City (TW)

(21) Appl. No.: 19/084,964

(22) Filed: Mar. 20, 2025

(30) Foreign Application Priority Data
Mar. 21, 2024 (TW) 113110614

(51) Int. Cl. H01R 13/719; H01R 24/64; H04L 12/10

(52) U.S. Cl. CPC H01R 13/719; H01R 24/64; H04L 12/10; H01R 2201/04

(57) ABSTRACT

An electrical isolation module for Power over Ethernet includes a network terminal connection section, a network chip connection section, and an isolation circuit. The network terminal connection section includes a plurality of first pins. The network chip connection section includes a plurality of second pins. The isolation circuit includes a transformer, a common mode choke, and a transient voltage suppressor. The common mode choke is connected between the transformer and the network terminal connection section. The transient voltage suppressor is connected between the transformer and the network chip connection section.

### CROSS-REFERENCE TO RELATED APPLICATION

This non-provisional application claims priority under 35 U.S.C. § 119(a) to patent application No. 113110614 filed in Taiwan, R.O.C. on Mar. 21, 2024, the entire contents of which are hereby incorporated by reference.

### BACKGROUND

### Technical Field

The present disclosure relates to power over Ethernet, and particularly, to an electrical isolation module for power over Ethernet and a connector socket and an electronic device for the same.

### Related Art

The main functions of a network transformer include undistorted signal transmission, impedance matching, electrical isolation, and the like. For example, when being used in Ethernet, the network transformer is mainly arranged between a PHY chip and a connector RJ45 to enhance signal transmission, and meanwhile isolate the PHY chip from an external environment to enhance the anti-interference ability. In addition, to avoid the impact of lightning surges on Ethernet, additional protection elements may be installed generally.

However, a conventional network transformer does not integrate the protection elements and the network transformer into a module in general, so it is needed to install the additional protection elements during the use of the network transformer, resulting in an increase in the overall volume, thus affecting the overall costs. In addition, when using the network transformer at a user terminal, it is also needed to look for matched protection elements, resulting in inconvenience in the use of the conventional network transformer.

### SUMMARY

In view of above, an electrical isolation module for power over Ethernet is provided. The electrical isolation module includes a network terminal connection section, a network chip connection section, and an isolation circuit. The network terminal connection section includes a plurality of first pins. The network chip connection section includes a plurality of second pins. The isolation circuit includes a transformer, a common mode choke, and a transient voltage suppressor. The common mode choke is connected between the transformer and the network terminal connection section. The transient voltage suppressor is connected between the transformer and the network chip connection section.

In one embodiment, the transformer includes a first winding and a second winding. The first winding is connected to the common mode choke, and the second winding is connected to the transient voltage suppressor. The transient voltage suppressor is connected in parallel with the second winding, and two ends of the transient voltage suppressor are respectively connected to two of the second pins.

In one embodiment, the common mode choke includes two third windings. Each third winding is connected in series with the first winding and one of the first pins.

In one embodiment, a parasitic capacitance value of the transient voltage suppressor is in negative correlation with a support transmission speed of a network connection port for power over Ethernet.

The present disclosure further provides a connector socket. The connector socket includes a socket body and at least one electrical isolation module. The socket body includes a plug interface and an accommodating chamber relative to the plug interface. The electrical isolation module is located in the accommodating chamber. The electrical isolation module includes a network terminal connection section, a network chip connection section, and an isolation circuit. The network terminal connection section includes a plurality of first pins. The network chip connection section includes a plurality of second pins. The isolation circuit includes a transformer, a common mode choke, and a transient voltage suppressor. The common mode choke is connected between the transformer and the network terminal connection section. The transient voltage suppressor is connected between the transformer and the network chip connection section.

In one embodiment, a parasitic capacitance value of the transient voltage suppressor is in negative correlation with a support transmission speed of the connector socket.

In one embodiment, the connector socket further includes at least one filter circuit. At least one of the first winding and the second winding is provided with a center tap, and each center tap is connected to one of the at least one filter circuit.

The present disclosure further provides an electronic device. The electronic device includes the above-mentioned connector socket.

The electrical isolation module, the connector socket, and the electronic device according to some embodiments of the present disclosure have the following effects: (1) a protection element and a network transformer are integrated into a module to reduce the overall volume. (2) The electrical isolation module can enhance and transmit a differential signal sent by a network chip to isolate a direct current component in the signal. (3) Electromagnetic interference can be effectively suppressed by the common mode choke. (4) A low-impedance path is provided for common mode current to reduce the common mode current/voltage. Moreover, direct current bias is provided to ensure normal operation of a receiving circuit and a transmitting circuit, different capacitance values can be selected to provide a low-impedance return path, and lower impedance can be provided at different problem frequency points, so that signal transmission is optimized.

### BRIEF DESCRIPTION OF THE DRAWINGS

FIG. 1 is a schematic circuit diagram of an electrical isolation module according to an embodiment;

FIG. 2 is a schematic appearance diagram of an electrical isolation module according to an embodiment;

FIG. 3 is a schematic appearance diagram of a connector socket according to an embodiment; and

FIG. 4 is a partial perspective view of a connector socket according to an embodiment.

### DETAILED DESCRIPTION

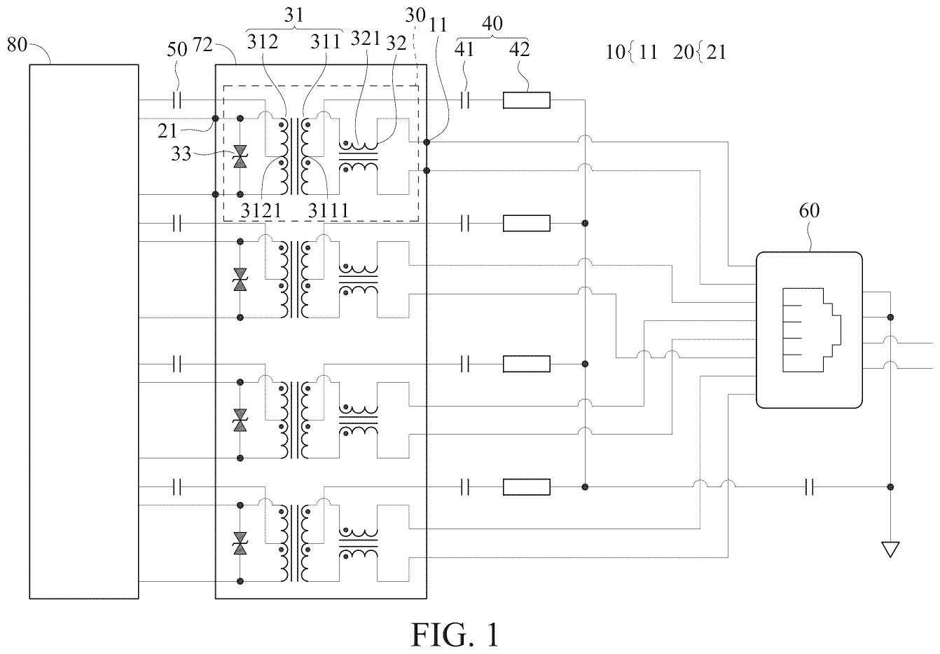

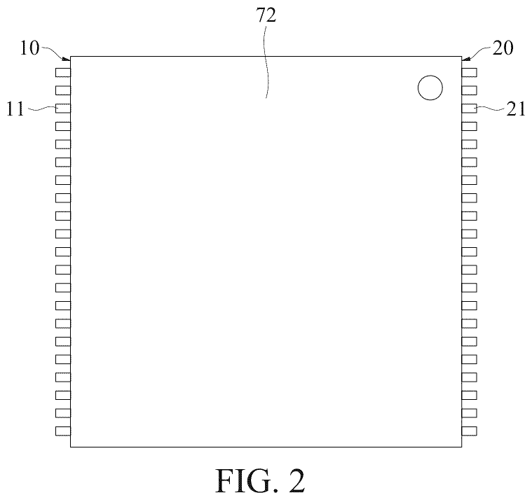

Referring to FIG. 1 and FIG. 2, the present disclosure provides an electrical isolation module 72 for power over Ethernet, which includes a network terminal connection section 10, a network chip connection section 20, and isolation circuits 30. Each isolation circuit 30 includes a transformer 31, a common mode choke 32, and a transient voltage suppressor 33.

Referring to FIG. 1 and FIG. 2, the network terminal connection section 10 includes a plurality of first pins 11. In some embodiments, 12 first pins 11 are provided. The network terminal connection section 10 is configured to connect a network terminal. In some embodiments, the network terminal connection section 10 is connected to a plug interface 60, and the plug interface 60 is configured to connect the network terminal, so that the network terminal connection section 10 is connected to the network terminal. In some embodiments, the plug interface 60 is an RJ45 interface.

Referring to FIG. 1 and FIG. 2, the network chip connection section 20 includes a plurality of second pins 21. In some embodiments, 12 second pins 21 are provided. The network chip connection section 20 is configured to connect a network chip 80. In some embodiments, the network chip 80 is a physical layer (PHY) chip.

Referring to FIG. 1 and FIG. 2, in some embodiments, the transformer 31 includes a first winding 311 and a second winding 312. The first winding 311 is connected to the common mode choke 32, and the second winding 312 is connected to the transient voltage suppressor 33. The transient voltage suppressor 33 is connected in parallel with the second winding 312, and two ends of the transient voltage suppressor 33 are connected to two of the plurality of second pins 21 respectively. In some embodiments, the first winding 311 is connected to one of the plurality of first pins 11 at a first center tap 3111, and a filter circuit 40 is arranged between the first center tap 3111 and the plug interface 60. In some embodiments, the filter circuit 40 includes a capacitor 41 and a resistor 42. In some embodiments, the second winding 312 is connected to one of the plurality of second pins 21 at a second center tap 3121, and a filter circuit 50 is arranged between the second center tap 3121 and the network chip 80.

In some embodiments, the filter circuit 50 is a capacitor.

Referring to FIG. 1 and FIG. 2, the common mode choke 32 is connected between the transformer 31 and the network terminal connection section 10. In some embodiments, the common mode choke 32 includes two third windings 321, and each third winding 321 is connected in series between the corresponding first winding 311 and one of the first pins 11.

In some embodiments, the number of isolation circuits 30 in the electrical isolation module 72 corresponds to the number of first pins 11 and second pins 21. That is, each isolation circuit 30 is connected to three of the plurality of first pins 11 and three of the plurality of second pins 21 respectively, so when the number of the first pins 11 and the number of the second pins 21 are 12, the number of the isolation circuits 30 is 4.

Referring to FIG. 1 and FIG. 2, the transient voltage suppressor 33 is connected between the transformer 31 and the network chip connection section 20. The transient voltage suppressor 33 is configured to protect the electrical isolation module 72, so as to avoid negative effects caused by lightning surges. In some embodiments, a parasitic capacitance value of the transient voltage suppressor 33 is in negative correlation with a support transmission speed of a network connection port for power over Ethernet. For example, when the transmission speed is 1 Gbps, the parasitic capacitance value is 2 pF; when the transmission speed is 2.5 Gbps, the parasitic capacitance value is 1 pF; and when the transmission speed is 10 Gbps, the parasitic capacitance value is 0.2 pF.

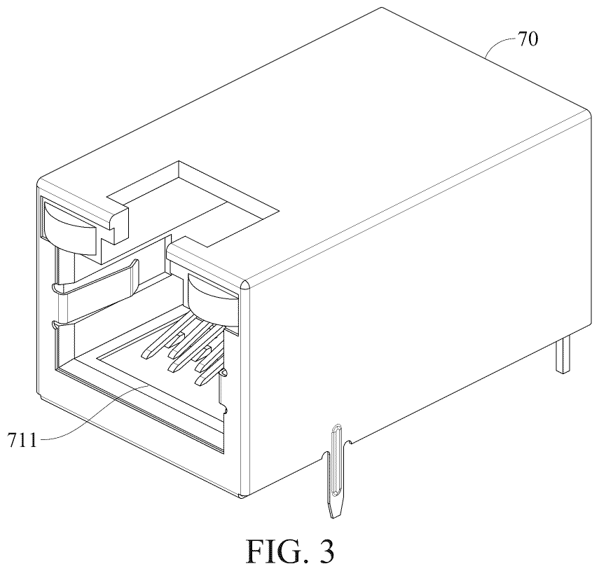

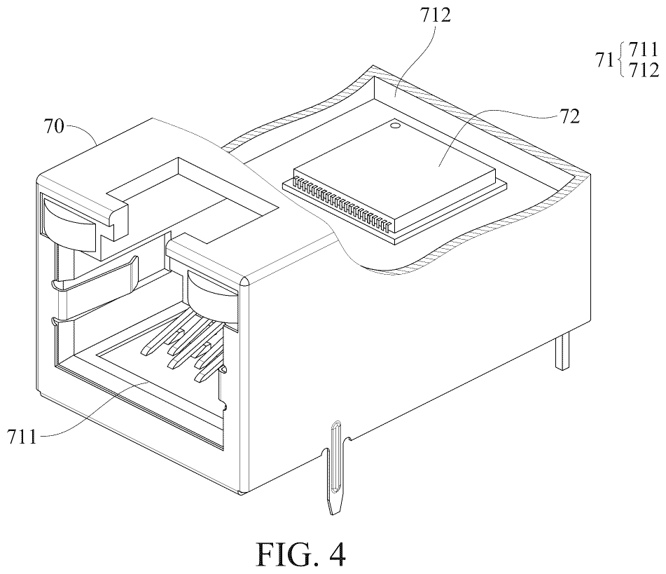

Referring to FIG. 3 and FIG. 4, in some embodiments, the present disclosure further provides a connector socket 70, which includes a socket body 71, and at least one electrical isolation module 72. The socket body 71 includes a plug interface 711 and an accommodating chamber 712 relative to the plug interface 711. The plug interface 711 in FIG. 3 and FIG. 4 is equivalent to the plug interface 60 in FIG. 1. The electrical isolation module 72 is arranged in the accommodating chamber 712. The implementation mode of the electrical isolation module 72 is as described above, which will not be repeated here. In some embodiments, the parasitic capacitance value of the transient voltage suppressor 33 is in negative correlation with a support transmission speed of the connector socket 70.

In some embodiments, the present disclosure further provides an electronic device for power over Ethernet, and the electronic device includes the connector socket 70 described above. The implementation mode of the electronic device is as described above, which will not be repeated here. In some embodiments, the electronic device may be power sourcing equipment (PSE) or a powered device (PD).

The electrical isolation module 72, the connector socket 70, and the electronic device according to some embodiments of the present disclosure have the following effects: (1) a protection element (the transient voltage suppressor 33) and a network transformer (the transformer 31 and the common mode choke 32) are integrated into a module to reduce the overall volume. (2) The electrical isolation module 72 can enhance and transmit a differential signal sent by the network chip 80 (such as a PHY chip) by the first windings 311 and the second windings 312 to block a direct current component in the signal. In some embodiments, the electrical isolation module 72 can withstand a voltage of 1.5 KV-3 KV to play a protection effect for preventing from lightning. (3) Electromagnetic Interference (EMI) can be effectively suppressed by the common mode choke 32. (4) The first center taps 3111 are connected to the first pins 11, the second windings 312 are connected to the second pins 21, thus a low-impedance path is provided for common mode current, and the common mode current/voltage is reduced. Moreover, direct current bias is provided to ensure normal operation of a receiving circuit and a transmitting circuit, different capacitance values can be selected to provide a low-impedance return path, and lower impedance can be provided at different problem frequency points, so that signal transmission is optimized.

What is claimed is:

1. An electrical isolation module for power over Ethernet, comprising:
a network terminal connection section, comprising a plurality of first pins;
a network chip connection section, comprising a plurality of second pins; and
at least one isolation circuit, wherein the isolation circuit comprises:
a transformer;
a common mode choke, connected between the transformer and the network terminal connection section; and
a transient voltage suppressor, connected between the transformer and the network chip connection section.

2. The electrical isolation module according to claim 1, wherein the transformer comprises a first winding and a second winding, the first winding is connected to the common mode choke, the second winding is connected to the transient voltage suppressor, wherein the transient voltage suppressor is connected in parallel with the second winding, and two ends of the transient voltage suppressor are respectively connected to two of the second pins.

3. The electrical isolation module according to claim 2, wherein the common mode choke comprises two third windings, and each third winding is connected in series with the first winding and one of the first pins.

4. The electrical isolation module according to claim 1, wherein a parasitic capacitance value of the transient voltage suppressor is in negative correlation with a support transmission speed of a network connection port for power over Ethernet.

5. A connector socket, comprising:
a socket body, comprising a plug interface and an accommodating chamber relative to the plug interface; and
at least one electrical isolation module, located in the accommodating chamber, wherein the electrical isolation module comprises:
a network terminal connection section, comprising a plurality of first pins;
a network chip connection section, comprising a plurality of second pins; and
at least one isolation circuit, wherein the isolation circuit comprises:
a transformer;
a common mode choke, connected between the transformer and the network terminal connection section; and
a transient voltage suppressor, connected between the transformer and the network chip connection section.

6. The connector socket according to claim 5, wherein the transformer comprises a first winding and a second winding, the first winding is connected to the common mode choke, the second winding is connected to the transient voltage suppressor, wherein the transient voltage suppressor is connected in parallel with the second winding, and two ends of the transient voltage suppressor are respectively connected to two of the second pins.

7. The connector socket according to claim 6, wherein the common mode choke comprises two third windings, and each third winding is connected in series with the first winding and one of the first pins.

8. The connector socket according to claim 6, wherein a parasitic capacitance value of the transient voltage suppressor is in negative correlation with a support transmission speed of the connector socket.

9. The connector socket according to claim 6, further comprising at least one filter circuit, wherein at least one of the first winding and the second winding is provided with a center tap, and each center tap is connected to one of the at least one filter circuit.

10. An electronic device, comprising:
a connector socket, wherein the connector socket comprises:
a socket body, comprising a plug interface and an accommodating chamber relative to the plug interface; and
at least one electrical isolation module, located in the accommodating chamber, wherein the electrical isolation module comprises:
a network terminal connection section, comprising a plurality of first pins;
a network chip connection section, comprising a plurality of second pins; and
at least one isolation circuit, wherein the isolation circuit comprises:
a transformer;
a common mode choke, connected between the transformer and the network terminal connection section; and
a transient voltage suppressor, connected between the transformer and the network chip connection section.

11. The electronic device according to claim 10, wherein the transformer comprises a first winding and a second winding, the first winding is connected to the common mode choke, the second winding is connected to the transient voltage suppressor, wherein the transient voltage suppressor is connected in parallel with the second winding, and two ends of the transient voltage suppressor are respectively connected to two of the second pins.

12. The electronic device according to claim 11, wherein the common mode choke comprises two third windings, and each third winding is connected in series with the first winding and one of the first pins.

13. The electronic device according to claim 11, wherein a parasitic capacitance value of the transient voltage suppressor is in negative correlation with a support transmission speed of the connector socket.

14. The electronic device according to claim 11, further comprising at least one filter circuit, wherein at least one of the first winding and the second winding is provided with a center tap, and each center tap is connected to one of the at least one filter circuit.
